(19) United States
(12) Patent Application Publication
(10) Pub. No.: US 2002/0153784 A1
(43) Pub. Date: Oct. 24, 2002

(54) Housing and production method for an end winding

(76) Inventor: Uwe Kanppenberger, Muehlacker (DE)

Correspondence Address: Striker Striker & Stenby, 103 East Neck Road, Huntington, NY, 11743, US

(21) Appl. No.: 09/958,645

(22) PCT Filed: Jan. 24, 2001
(86) PCT No.: PCT/DE01/00265

(30) Foreign Application Priority Data
Feb. 11, 2000 (DE) 100 06 159.1
Sep. 12, 2000 (DE) 100 49 938.7

(51) Int. Cl. H02K 9/00

(52) U.S. Cl. 310/52; 310/270

(57) ABSTRACT

The invention relates to a housing for a fluid-cooled electric machine, having at least one stator winding head 1 and a bearing plate 2, 3.

It is provided that at least one fluid coolant conduit 4 is formed between the at least one stator winding head 1 and the bearing plate 2, 3.

The present invention also relates to methods for producing a stator winding head that is fluid-tight at least in some portions.

The invention relates to a housing for a fluid-cooled electric machine, having the characteristics recited in the preamble to claim 1. The present also relates to methods for producing a stator winding head that is fluid-tight at least in some portions, as generically defined by the preambles to claims 17, 22 and 31, as well as to an apparatus for performing the method of the invention.

### PRIOR ART

Fluid-cooled electric machines are used for instance as generators in motor vehicles.

From U.S. Pat. No. 5,798,586, a housing of this generic kind for a fluid-cooled electric machine is known, in which a fluid coolant conduit is disposed on the outside of the bearing plate and is formed by a separate tube, which is fixed by a pressure plate in recesses that are provided in the outside of the bearing plate.

The pressure plate and the tube or tubes and lines are additional components, which increase the mass of the housing as well as its production costs.

A housing of this generic type is also known from European Patent Disclosure EP 0 841 735 A1, in which certain portions of the housing wall are provided with fluid coolant conduits.

However, embodying such wall portions is complicated and therefore expensive.

### ADVANTAGES OF THE INVENTION

Because at least one fluid coolant conduit is provided in the housing of the invention for a fluid-cooled electric machine between the at least one stator winding head and the bearing plate, the cooling conduit is embodied in a simple and therefore economical way between two components that are already present anyway.

The cooling is furthermore effected virtually directly at the heat source, which is the stator wire.

By utilizing the structural space between the at least one stator winding head and the bearing plate, which was previously filled with air, an increase in the dimensions of it the electric machine is averted for the most part.

The bearing plate can be formed by an A-bearing plate and a B-bearing plate. Preferably, the at least one stator winding head and the bearing plate define the at least one fluid coolant conduit.

The fluid coolant conduit can be formed on one or both sides on the stator winding heads, and in other regions of the housing further fluid coolant conduits can be provided, if necessary or advantageous.

Since the at least one stator winding head enters into contact with the coolant, it is preferably fluid-tight by potting and/or impregnation.

The bearing plate preferably embraces the winding head as far as possible, and to that end it has faces for sealing purposes.

In the region of the at least one fluid coolant conduit between the at least one stator winding head and the bearing plate, sealing means are advantageously provided, which are preferably disposed between the sealing faces and the at least one stator winding head.

If inner and outer faces for sealing purposes are provided, the sealing means can be embodied by a first encompassing seal, which is disposed between the at least one stator winding head and the inner faces, and by a second encompassing seal, which is disposed between the at least one stator winding head and the outer sealing faces.

Regardless of how the sealing means are especially embodied, they are preferably releasable as needed.

To enable the exchange and circulation of coolant, the at least one fluid coolant conduit communicates with a fluid inlet and a fluid outlet, and the fluid inlet and the fluid outlet are disposed in the bearing plate.

If the bearing plate is formed by an A-bearing plate and a B-bearing plate, the fluid inlet can be associated with the A-bearing plate, while the fluid outlet is associated with the B-bearing plate.

The stator connection wires can optionally be separately sealed off and/or extended outside through the bearing plate, specifically through one or more apertures of the sealing means.

The production methods according to the invention will be addressed below.

Because a first version of the method for producing a stator winding head which is fluid-tight at least in some portions and which has at least one A-winding head, which includes the following steps: a) providing a first forming tool, which is adapted to the A-winding head; b) filling potting composition into the forming tool; c) plunging the A winding head into the forming tool filled with potting composition; d) curing the potting composition; e) separating the potted A-winding head from the first forming tool, in order to obtain a winding head whose A-winding head is at least partly covered by a first covering element of cured potting composition, at least a fluid-tight portion of the A-winding head can be formed economically. The potting composition is fluid-proof and preferably is a good heat conductor.

In the first version of the method of the invention, it is preferably also provided that by means of step a), a first forming tool is provided, which has a substantially U-shaped cross section, which on the outside of the first free leg of the U-shaped cross section has a first groove that is intended to equip the first covering element with a first seat, and/or which on the outside of the second free leg of the U-shaped cross section has a second groove that is intended to equip the first covering element with a second seat. The first and/or second seat can be embodied as a flat seat or an angled seat, depending on the form of the first and second groove, respectively. Regardless of the special design of the seats, in the mounted state of the winding head these seats can act as sealing faces, especially in combination with suitable sealing means.

If the winding head also has a B-winding head, the method of the first version preferably also includes the following steps: f) providing a second forming tool, which is adapted to the B-winding head; g) filling potting composition into the second forming tool; h) plunging the B-winding head into the second forming tool filled with potting composition; i) curing the potting composition; j) separating the potted B-winding head from the second forming tool, in order to obtain a winding head whose B-winding head is at least partly covered by a second covering element of cured potting composition. In this case as well, the potting composition is fluid-proof and preferably is a good heat conductor. By these further steps, a winding head can be produced that can for instance be used with the housing according to the invention.

Preferably, by means of step f), a first forming tool is provided, which has a substantially U-shaped cross section, which on the outside of the first free leg of the U-shaped cross section has a third groove that is intended to equip the second covering element with a third seat, and/or which on the outside of the second free leg of the U-shaped cross section has a fourth groove that is intended to equip the second covering element with a fourth seat. The first and/or second seat can be embodied as a flat seat or an angled seat, depending on the form of the first and second groove, respectively. Regardless of the special design of the seats, in the mounted state of the winding head these seats can act as sealing faces, especially in combination with suitable sealing means.

In the first version of the method of the invention, it is preferably also provided that in the first covering element and/or in the second covering element, at least one opening is provided, through which stator connection wires extend, in sealed fashion. This opening can for instance be provided on one end face of the winding head.

Because a second version of the method for producing a stator winding head that has at least one A-winding head, which version includes the following steps: k) providing a cup-shaped first forming part; l) introducing at least a portion of the A-winding head into the first cup-shaped a forming part (24, 27), an A-winding head that is at least fluid-proof in some portions can be created. To that end, the cup-shaped forming part is fluid-proof and preferably has good heat conductivity.

The cup-shaped first forming part preferably has a first seat and/or a second seat on its edge. To that end, the edge of the cup-shaped forming part can be widened in collarlike fashion. To produce the cuplike element, depending on the material, injection molding or deep drawing methods can be considered.

The method of the invention in the second version preferably further includes the following steps: m) providing a cup-shaped second forming part; n) introducing at least a portion of the B-winding head into the second cup-shaped forming part, so that the B-winding head can also be sealed off at least in some portions.

The cup-shaped second forming part can also have a third seat and/or a fourth seat on its edge, to which end once again a corresponding collarlike design of the edge can be provided.

The first cup-shaped forming part and/or the second cup-shaped forming part can for instance be a plastic forming part or an aluminum forming part. In particular when a plastic forming part is involved, the cup-shaped forming part can have thin walls yet still be provided with a solid collarlike edge. Particularly in the case of an aluminum forming part, it can be provided that the wall thickness is approximately the same throughout.

The method of the invention in the second version can further include the following step: o) deforming at least a portion of the first cup-shaped forming part and/or at least a portion of the second cup-shaped forming part in such a way that the inner wall of the first cup-shaped forming part and/or the inner wall of the second cup-shaped forming part rests at least in some portions on the A-winding head and the B-winding head, respectively. This contact of the cup-shaped forming part or parts can be advantageous not only for the sake of sealing off from fluid but in particular to improve heat conductivity as well.

This step o) can include the introduction of at least a portion of the first cup-shaped forming part and/or of at least a portion of the second cup-shaped forming part into an overpressure chamber. As a result of the overpressure, the cup-shaped forming parts are pressed against the winding head. In that case, it is especially advantageous if the opening of the overpressure chamber fits by positive engagement together with the seats, since the overpressure can then be exerted solely on the outside of the cup-shaped forming part or parts. It can also be advantageous if, before the introduction into the overpressure chamber, potting composition is placed at least in some portions between the cup-shaped forming part and the winding head. This potting composition is preferably heat-conducting and (initially) of low viscosity. The curing of the potting composition can, as in all the other cases, be done in an oven, for instance. The combination of negative pressure and heat is also conceivable.

In the method of the invention in the second version, it can be provided in each case that it includes the at least partial filling up of an interstice between the first cup-shaped forming part and the A-winding head and/or the at least partial filling up of an interstice between the second cup-shaped forming part and the B-winding head with potting composition. Especially when one or two cup-shaped aluminum forming parts are used, the potting composition can for instance seal off the stator connection wires that are extended through at least one aperture in the cup-shaped aluminum forming parts.

Regardless of the use of potting composition, in the second version of the method of the invention, it can also be provided that in the first cup-shaped forming part and/or in the second cup-shaped forming part, at least one opening is provided, through which stator connection wires can extend, in sealed fashion.

A third version of the method of the invention relates to the production of a stator winding head which is fluid-tight at least in some portions, which has at least one winding head that is disposed adjacent to a stator iron, and this method includes at least the following steps: p) disposing a first forming part and/or a second forming part and/or a third forming part and/or a fourth forming part on the stator iron, in such a way that each forming part extends at least in some portions in spaced-apart fashion from the winding head; q) filling up the spacings between the forming parts and the winding head with potting composition; r) coating still-bare portions of the winding head with potting composition. Steps q) and r) can be performed either simultaneously or in succession. Also by this method, a winding head that is fluid-proof in at least some portions can be produced economically. For instance, if the forming parts form one or more seats, then the force exerted on these seats is transmitted at least in part to the stator irons, which can be advantageous in certain applications.

In the third version of the method of the invention, the layer thickness of the potting composition between the first forming part and/or the second forming part and/or the third forming part and/or the fourth forming part is thicker than on other portions of the winding head. At least in the regions outside the forming parts, the potting composition is fluid-proof and fluid-tight. A lesser thickness of potting composition in the regions outside the forming parts can contribute to better heat dissipation.

In the third version of the method of the invention, it can be provided that the potting composition forms an opening, through which stator connection wires extend in sealed fashion.

It can also be provided that the first forming part, on its side remote from the winding head forms a first seat, and/or that the second forming part, on its side remote from the winding head forms a second seat, and/or that the third forming part, on its side remote from the winding head forms a third seat, and/or that the fourth forming part, on its a, side remote from the winding head forms a fourth seat, and the possibilities for design and use of such seats that have already been mentioned pertain here as well.

In all the versions of the method of the invention, the opening can be embodied as an essentially cylindrical extension.

This cylindrical extension can form at least one further seat, which can for instance serve to provide sealing from the bearing plate, especially in conjunction with suitable sealing means.

Also in all the versions of the method of the invention, the provision of sealing means on the first seat and/or the second seat and/or the third seat and/or the fourth seat and/or in the region of the further seat can be a component of the method. These sealing means can for instance be formed by O rings. However, sealing pastes and the like can also be used.

The scope of the associated claims also includes apparatuses that are suitable for performing the method of the invention.

It will be pointed out that the individual steps and characteristics of the versions mentioned of the method of the invention can be combined practically arbitrarily. In particular, in some cases it can be advantageous to provide different versions, or mixed forms, of the methods for the A-winding head and the B-winding head.

### DRAWINGS

The invention will be described in further detail below in conjunction with the associated drawings.

Shown are:

FIG. 1, an electric machine, which has a housing in accordance with one exemplary embodiment of the present invention;

FIG. 2a, a forming tool that is used in one version of the method of the invention.

FIG. 2b, a winding head disposed in some portions in the forming tool of FIG. 2a;

FIG. 2c, a winding head with a first covering element of potting composition;

FIG. 2d, the winding head of FIG. 2c with a second covering element of potting composition;

FIG. 2e, the winding head of FIG. 2d, disposed in a bearing plate;

FIG. 3a, a first cup-shaped aluminum forming part;

FIG. 3b, a winding head with the cup-shaped aluminum forming part of FIG. 3a;

FIG. 3c, the winding head of FIG. 3b with a second cup-shaped aluminum forming part;

FIG. 3d, the winding head of FIG. 3c, disposed in a bearing plate;

FIG. 4a, a first cup-shaped plastic forming part;

FIG. 4b, a winding head with the cup-shaped plastic forming part of FIG. 4a, disposed in an overpressure chamber;

FIG. 4c, the winding head of FIG. 3b with a second cup-shaped plastic forming part;

FIG. 4d, the winding head of FIG. 3c, disposed in a bearing plate;

FIG. 5a, part of a winding head with first and second plastic forming parts disposed on the stator iron;

FIG. 5b, the winding head of FIG. 5a as a whole, partly coated with potting composition;

FIG. 5c, the winding head of FIG. 5b with third and fourth plastic forming parts and coated with potting composition;

FIG. 5d, the winding head of FIG. 5c, disposed in a bearing plate;

### DESCRIPTION OF THE EXEMPLARY EMBODIMENTS

In the drawings, identical or similar parts are provided with the same or similar reference numerals, so that repeated description of identical or similar parts can be dispensed with.

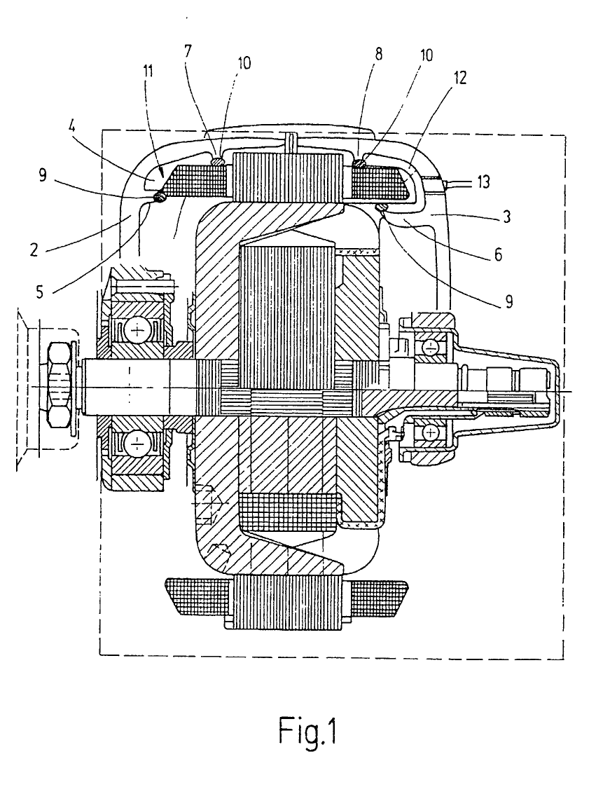

In FIG. 1, an 1b in the form of a generator is shown.

This electric machine has the at least one stator winding head 1 and a bearing plate, which is formed by an A-bearing plate 2 and a B-bearing plate 3.

The fluid coolant conduit 4 is defined by the at least one stator winding head 1, which is sealed off by potting and/or impregnation, and the bearing plate 2, 3.

Although this is not shown, it is possible, as noted, to provide further fluid coolant conduits in the housing in addition to the fluid coolant conduit 4.

The bearing plate 2, 3 embraces the at least one winding head 1 as much as possible to form the fluid coolant conduit 4, specifically by means of inner faces 5, 6 for sealing purposes and outer faces 7, 8 for sealing purposes.

The faces 5, 6, 7, 8 for sealing purposes cooperate with encompassing seals 9, 10; the seal 9 is disposed between the inner faces 5, 6 for sealing purposes and the at least stator winding head 1, while the seal 10 is disposed between the outer faces 7, 8 for sealing purposes and the at least one stator winding head 1.

The at least one fluid coolant conduit 4 communicates with a fluid inlet 11 and a fluid outlet 12, so that the coolant, which can for instance be water, can be pumped through the fluid coolant conduit 4.

As shown only schematically, the stator connection wires 13 are extended out through the B-bearing plate 3 in such a way that they are separately sealed off.

The present invention utilizes the structural space to between two components present anyway, so that the fluid coolant conduit 4 can be embodied economically without substantially changing the dimensions of the electric machine.

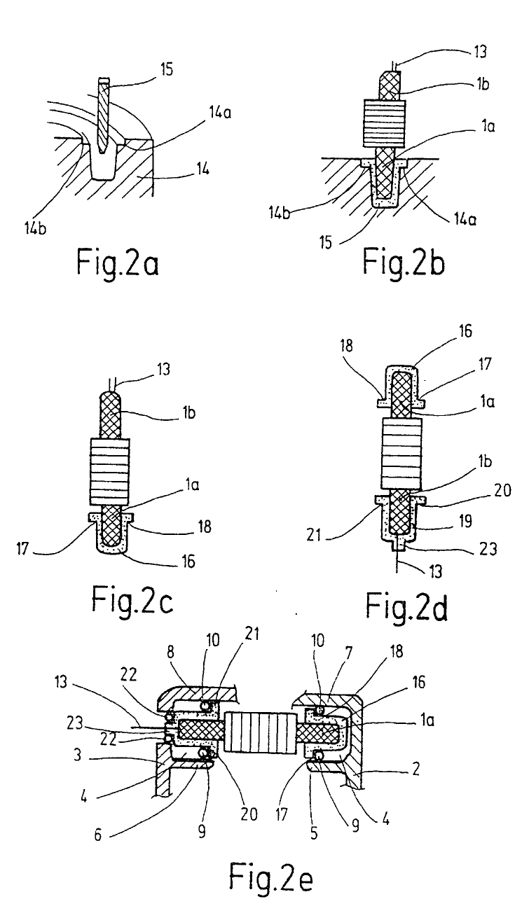

FIG. 2a shows a forming tool that is used in the first version of the method of the invention. The forming tool, identified overall by reference numeral 14, has a recess which has a substantially U-shaped cross section. On the outside of the first free leg of the U-shaped cross section, a first groove 14a is provided, while on the outside of the second free leg of the U-shaped cross section, a second groove 14b is provided. The first groove 14a and the second groove 14b serve to equip the first covering element 16, to be produced with the aid of the forming tool 14, with a first seat 17 and a second seat 18, as will be described in further detail hereinafter. For performing the method of the invention according to the first version, the forming tool 14 is first filled with still-fluid potting composition 15, which at least in the cured state has good heat conductivity and is fluid-proof and fluid-tight.

FIG. 2b shows a winding head which has an A-winding head 1a and a B-winding head 1b. From the B-winding head 1b, stator connection wires 13 shown only schematically extend outward. The A-winding head 1a is dipped in portions into the forming tool 14, filled with potting composition 15. In this position, the potting composition 15 is cured, for instance in an oven.

FIG. 2c shows the winding head of FIG. 2b; the A-winding head 1a has been separated from the forming tool 14. The cured potting composition 15 forms a first covering element 16, which surrounds the A-winding head 1a in some portions and seals it off in fluid-tight and fluid-proof fashion. The first covering element 16 is widened in collarlike fashion on its edge by the action of the first groove 14a and the second groove 14b, thus forming a first seat 17 and a second seat 18. The first seat 17 and the second seat 18 are embodied as angled seats in this case, and are intended, at the latest in the mounted state of the winding head, for cooperation with sealing means 9, 10.

FIG. 2d shows the winding head of FIG. 2c with a second covering element 19 of cured potting composition 15. The second covering element 19 was formed in a manner corresponding to the first covering element 16 with the aid of a second forming tool, not shown. The second forming tool, not shown, differs from the first forming tool 14 in that in its bottom region it is shaped in such a way that the stator connection wires 13 extend, sealed, through an opening 23, which is embodied cylindrically. The second covering element 19 of cured potting composition 15 has a third seat 20 and a fourth seat 21, which are formed in a way corresponding to the first seat 17 and second seat 18.

FIG. 2e shows the winding head of FIG. 2d, disposed in a bearing plate. The bearing plate is formed by an A-bearing plate 2 and a B-bearing plate 3. The bearing plate has inner faces 5, 6 and outer faces 7, 8, which are provided for sealing purposes. Between the inner faces 5, 6 and the first seat 17 and the third seat 20, a sealing means 9 in the form of an O ring is provided. Correspondingly, between the outer faces 7, 8 and the second seat 18 and the fourth seat 21, a sealing means 10 is provided, which is also formed by an 0 ring. A further sealing means 22 seals the cylindrical extension 23 off from an aperture in the B-bearing plate, through which stator connection wires 13 are extended outward. The fluid coolant conduit thus formed in a sealed fashion is designated by reference numeral 4.

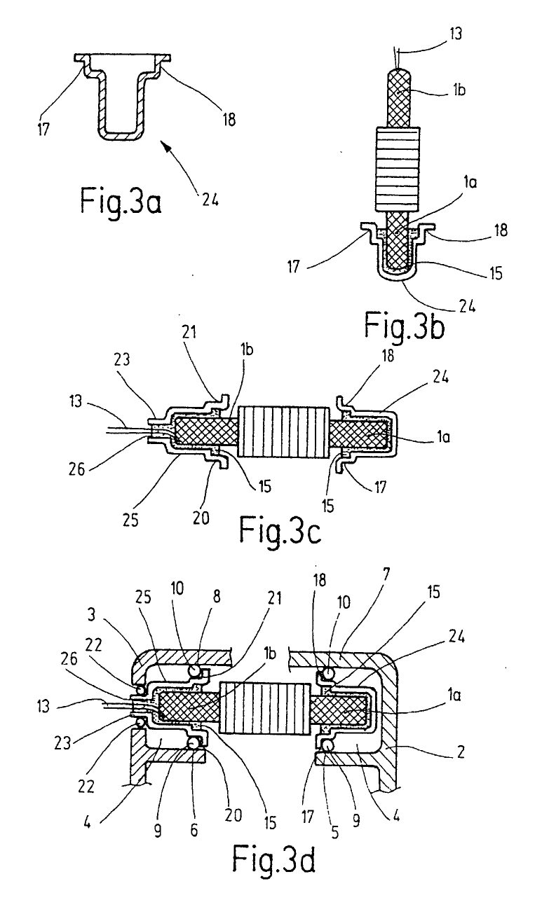

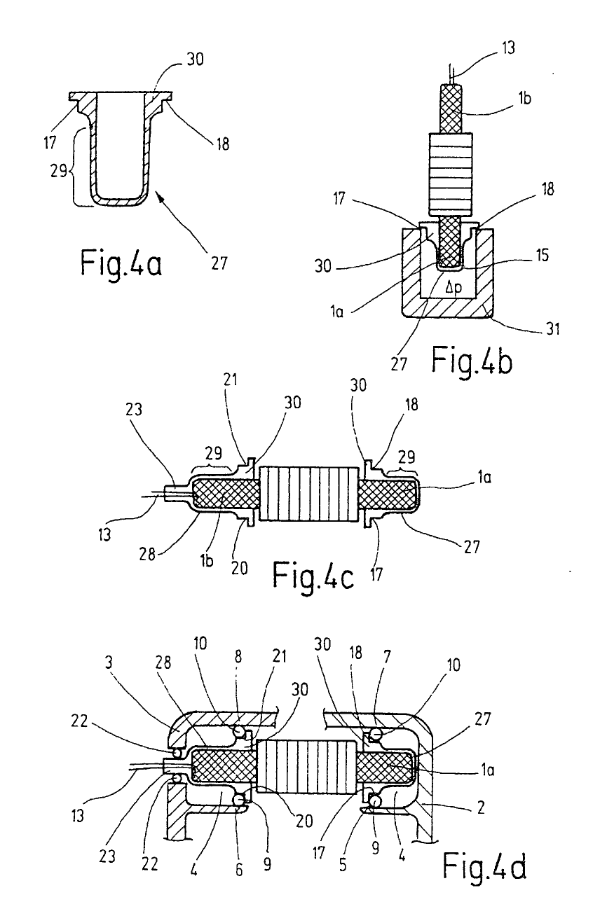

FIGS. 3a-3d and 4a-4d pertain to the second version of the method of the invention.

First, in conjunction with FIGS. 3a-3d, a first exemplary embodiment of this version will be explained, in which an aluminum forming part 24 is used that is shown in FIG. 3a. The first aluminum forming part 24 is designed in cup-shaped fashion and has a collar, which forms a first seat 17 and a second seat 18. This kind of aluminum forming part can be produced by deep drawing, for instance.

FIG. 3b shows a winding head whose A-winding head 1a is dipped in portions into the first cup-shaped aluminum forming part 24, which was filled beforehand with potting composition 15.

FIG. 3c shows the winding head of FIG. 3b with a second cup-shaped aluminum forming part 25, which differs from the first aluminum forming part 24 only in having an aperture 26 which is formed in the form of a cylindrical extension, so that the stator connection wires 13 can be extended to the outside. Between the B-winding head 1b and the second aluminum forming part 25, there is again potting composition 15, which has been cured for instance with the aid of an oven. The potting composition 15 seals off the stator connection wires 13 from the second aluminum forming part 25. This second cup-shaped aluminum forming part 25 also has a third seat 20 and a fourth seat 21.

FIG. 3d shows the winding head of FIG. 3c, disposed in a bearing plate. The cooperation of the winding head, which is fluid-tight in portions, with the bearing plate is essentially equivalent to the version of FIG. 2e, so a detailed description will not be made again at this point.

In conjunction with FIGS. 4a-4d, a description will be made of a second exemplary embodiment of the second version of the method of the invention.

FIG. 4a shows a first cup-shaped plastic forming part 27. On its upper edge, this plastic forming part 27 has a collar 30, which in contrast to the aluminum forming part 24 is embodied solidly. A first seat 17 and a second seat 18 are formed on the collar 30. The cup-shaped portion 29 below the collar 30 is embodied with thin walls and has a wall thickness of approximately 0.1 mm, for instance.

FIG. 4b shows a winding head whose A-winding head 1a is introduced in portions into the first cup-shaped plastic forming part 27, which has been filled beforehand with potting composition 15, which in this case is not only a good heat conductor but is preferably also of low viscosity. The first cup-shaped plastic forming part 27 is disposed in an overpressure chamber 31, which is shown only schematically. The first seat 17 and the second seat 18 can contribute to sealing off from the overpressure chamber 31. As a result of the overpressure prevailing in the overpressure chamber 31, the thin-walled portion 29 of the cup-shaped plastic forming part 27 is pressed against the individual wires of the A-winding head 1a. The curing of the potting composition can again be done by delivering heat, and it is considered advantageous to combine the delivery of heat with the overpressure.

FIG. 4c shows the winding head of FIG. 4b with a second cup-shaped plastic forming part 28, which is essentially equivalent to the first plastic forming part 27 and was secured in the same way. The plastic forming part 28 differs from the plastic forming part 27 in having an opening 23 in the form of a cylindrical extension for the stator connection wires 13.

FIG. 4d shows the winding head of FIG. 4c, disposed in a bearing plate. Since the cooperation of the bearing plate with the winding head that is fluid-proof in portions is equivalent to that of the first version, which has been described at length in conjunction with FIG. 2e, a detailed description at this point will be dispensed with.

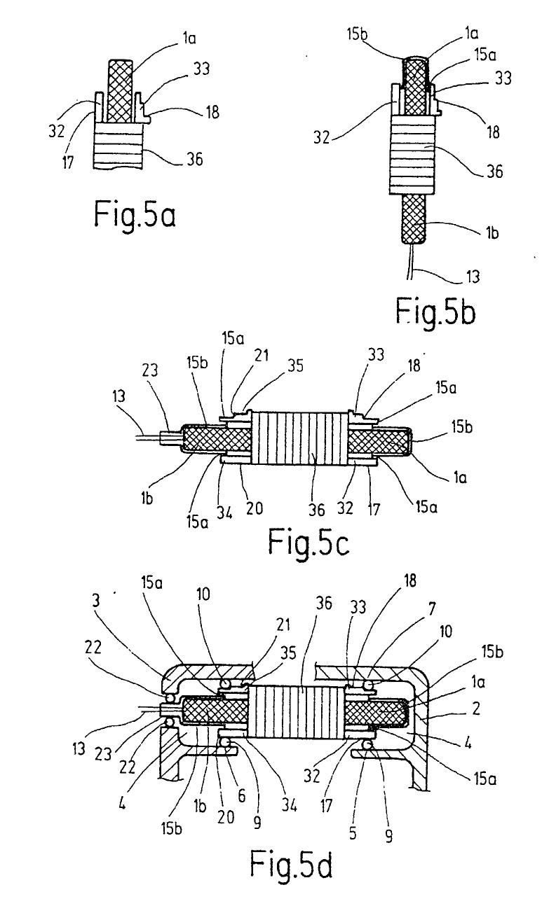

A description of the third version of the method of the invention follows in conjunction with FIGS. 5a-5d.

FIG. 5a shows part of a winding head with first and second forming parts 32, 33, disposed on the stator iron 36, which are preferably made from plastic. The first forming part 32 is also embodied substantially flat on its side remote from the winding head 1aand has a first seat 17 in the form of a flat seat. In contrast to this, the second forming part 33, on its side remote from the winding head 1a, is equipped with right-angled edges, which form a second seat 18 in the form of an angled seat. The angled form of the side, remote from the winding head 1a, of the second forming part 33 can also be used as a guide for the stator connection.

FIG. 5b shows the winding head of FIG. 5a as a whole, partly coated with potting composition. The potting composition 15a provided between the first and second forming parts 32, 33 and the A-winding head 1a is at least fluid-tight. The potting composition 15b, with which the free portion of the A-winding head 1a is coated, is additionally embodied as thin and has good heat conductivity.

FIG. 5c shows the winding head of FIG. 5b; a third forming part 34 and a fourth forming part 35 are additionally provided on the stator iron 36. The shape of the third forming part 34 is substantially equivalent to the shape of the first forming part 32; the third forming part 34 forms a third seat 20 in the form of a flat seat. The shape of the fourth forming part 35 is also essentially equivalent to the shape of the second forming part 33, and the fourth forming part 35 forms a fourth seat 21 in the form of an angled seat. The B-winding head 1b is also coated, like the A-winding head 1a, with potting composition 15a, 15b. However, on the left-hand end portion, in terms of FIG. 5c, of the B-winding head 1b, an opening 23 is provided, in the form of a cylindrical extension for the stator connection wires 13.

FIG. 5d shows the winding head of FIG. 5c, disposed in a bearing plate. Since the cooperation of this fluid-tight winding head with the bearing plate is equivalent essentially to the cooperation already explained in conjunction with FIG. 2e, a detailed description of FIG. 5d will be dispensed with at this point.

Although FIGS. 2-5 are associated with the various versions of the method of the invention, it can be advantageous for one or more method steps of the various versions to be combined with one another, to furnish a winding head which meets given requirements.

The above description of the exemplary embodiments of the present invention is solely for illustrative purposes and is not meant to limit the invention. Within the scope of the invention, various changes and modifications are possible without departing from the scope of the invention and its equivalents.

1. A housing for a fluid-cooled electric machine, having at least one stator winding head (1) and a bearing plate (2, 3), characterized in that between the at least one stator winding head (1) and the bearing plate (2, 3), at least one fluid coolant conduit (4) is provided.

2. The housing of one of the foregoing claims, characterized in that the bearing plate is formed by an A-bearing plate (2) and a B-bearing plate (3).

3. The housing of one of the foregoing claims, characterized in that the at least one stator winding head (1) and the bearing plate (2, 3) define the at least one fluid coolant conduit (4).

4. The housing of one of the foregoing claims, characterized in that the at least one fluid coolant conduit (4) is formed on one or both sides on the stator winding heads.

5. The housing of one of the foregoing claims, characterized in that in other regions of the housing, further fluid coolant conduits are provided.

6. The housing of one of the foregoing claims, characterized in that the at least one stator winding head (1) is fluid-tight as a result of potting and/or impregnation.

7. The housing of one of the foregoing claims, characterized in that the bearing plate (2, 3) has faces (5, 6, 7, 8) for sealing purposes.

8. The housing of one of the foregoing claims, characterized in that sealing means (9, 10) are provided in the region of the at least one fluid coolant conduit (4), between the at least one stator winding head (1) and the bearing plate (2, 3).

9. The housing of one of the foregoing claims, characterized in that the sealing means are provided between the faces (5, 6, 7, 8) for sealing purposes and the at least one stator winding head (1).

10. The housing of one of the foregoing claims, characterized in that inner faces (5, 6) and outer faces (7, 8) for sealing purposes are provided, and that the sealing means (9, 10) are embodied by a first encompassing seal (9), which is disposed between the at least one stator winding head (1) and the inner faces (5, 6), and by a second encompassing seal (10), which is disposed between the at least one stator winding head (1) and the outer faces (7, 8) for sealing purposes.

11. The housing of one of the foregoing claims, characterized in that the sealing means (9, 10) are releasable as needed.

12. The housing of one of the foregoing claims, characterized in that the at least fluid coolant conduit (4) communicates with a fluid inlet (11) and a fluid outlet (12).

13. The housing of one of the foregoing claims, characterized in that the fluid inlet (11) and the fluid outlet (12) are located in the bearing plate (2, 3).

14. The housing of one of the foregoing claims, characterized in that the fluid inlet (11) is located in the A-bearing plate (2).

15. The housing of one of the foregoing claims, characterized in that the fluid outlet (12) is located in the B-bearing plate.

16. The housing of one of the foregoing claims, characterized in that stator connection wires (13) are provided, which are separately sealed off and/or carried to the outside through the bearing plate (2, 3) by the sealing means (9, 10).

17. A method for producing a stator winding head which is fluid-tight at least in some portions and which has at least one A-winding head (1a), characterized in that it includes the following steps:
a) providing a first forming tool (14), which is adapted to the A-winding head (1a);
b) filling potting composition (15) into the forming tool (14);
c) plunging the A-winding head (1a) into the forming tool (14) filled with potting composition (15);
d) curing the potting composition (15);
e) separating the potted A-winding head (1a) from the first forming tool (14), in order to obtain a winding head whose A-winding head is at least partly covered by a first covering element (16) of cured potting composition (15).

18. The method of claim 17, characterized in that by means of step a), a first forming tool (14) is provided, which has a substantially U-shaped cross section, which on the outside of the first free leg of the U-shaped cross section has a first groove (14a) that is intended to equip the first covering element (16) with a first seat (17), and/or which on the outside of the second free leg of the U-shaped cross section has a second groove (14b) that is intended to equip the first covering element (16) with a second seat (18).

19. The method of claim 17 or 18, in which the winding head further has a B-winding head (1b), characterized in that it further includes the following steps:
f) providing a second forming tool, which is adapted to the B-winding head (1b);
g) filling potting composition (15) into the second forming tool (14);
h) plunging the B-winding head (1b) into the second forming tool filled with potting composition (15);
i) curing the potting composition (15);
j) separating the potted B-winding head (1b) from the second forming tool, in order to obtain a winding head whose B-winding head is at least partly covered by a second covering element (19) of cured potting composition (15).

20. The method of claim 19, characterized in that by means of step f), a first forming tool is provided, which has a substantially U-shaped cross section, which on the outside of the first free leg of the U-shaped cross section has a third groove that is intended to equip the second covering element (19) with a third seat (20), and/or which on the outside of the second free leg of the U-shaped cross section has a fourth groove that is intended to equip the second covering element (19) with a fourth seat (19).

21. The method of one of claims 17-20, characterized in that in the first covering element (16) and/or in the second covering element (19), at least one opening (23) is provided, through which stator connection wires (13) extend in sealed fashion.

22. A method for producing a stator winding head which is fluid-tight at least in some portions and which has at least one A-winding head (1a), characterized in that it includes the following steps:
k) providing a cup-shaped first forming part (24, 27);
l) introducing at least a portion of the A-winding head into the first cup-shaped forming part (24, 27).

23. The method of claim 22, characterized in that the cup-shaped first forming part (24, 27) has a first seat (17) and/or a second seat (18) on its edge.

24. The method of claim 22 or 23, in which the winding head also a B-winding head (1b), characterized in that it further includes the following steps:
m) providing a cup-shaped second forming part (25, 28);
n) introducing at least a portion of the B-winding head into the second cup-shaped forming part (25, 28).

25. The method of claim 24, characterized in that the cup-shaped second forming part (25, 28) has a third seat (20) and/or a fourth seat (21) on its edge.

26. The method of one of claims 22-25, characterized in that the first cup-shaped forming part (24, 27) and/or the second cup-shaped forming part (25, 28) is a plastic forming part (27, 28) or an aluminum forming part.

27. The method of one of claims 22-26, characterized in that it further includes the following step:
o) deforming at least a portion of the first cup-shaped forming part (24, 27) and/or at least a portion of the second cup-shaped forming part (25, 28) in such a way that the inner wall of the first cup-shaped forming part (24, 27) and/or the inner wall of the second cup-shaped forming part (25, 28) rests at least in some portions on the A-winding head and the B-winding head, respectively.

28. The method of claim 27, characterized in that step o) includes the introduction of at least a portion of the first cup-shaped forming part (24, 27) and/or of at least a portion of the second cup-shaped forming part (25, 28) into an overpressure chamber (31).

29. The method of one of claims 22-28, characterized in that it includes the at least partial filling up of an interstice between the first cup-shaped forming part (24, 27) and the A-winding head and/or the at least partial filling up of an interstice between the second cup-shaped forming part (25, 28) and the B-winding head with potting composition (15).

30. The method of one of claims 22-29, characterized in that in the first cup-shaped forming part (24, 27) and/or in the second cup-shaped forming part (25, 28), at least one opening (23) is provided, through which stator connection wires (13) can extend in sealed fashion.

31. A method for producing a stator winding head which is fluid-tight at least in some portions, which has at least one winding head (1a, 1b) that is disposed adjacent to a stator iron (36), characterized in that it includes the following steps:
p) disposing a first forming part (32) and/or a second forming part (33) and/or a third forming part (34) and/or a fourth forming part (35) on the stator iron (36), in such a way-that each forming part (32, 33, 34, 35) extends at least in some portions in spaced-apart fashion from the winding head (1a, 1b);
q) filling up the spacings between the forming parts (32, 33, 34, 35) and the winding head (1a, 1b) with potting composition (15);
r) coating still-bare portions of the winding head (1a, 1b) with potting composition (15).

32. The method of claim 31, characterized in that the layer thickness of the potting composition (15) between the first forming part (32) and/or the second forming part (33) and/or the third forming part (34) and/or the fourth forming part (35) is thicker than on other portions of the winding head (1a, 1b).

33. The method of claim 31 or 32, characterized in that the potting composition (15) forms an opening (23), through which stator connection wires (13) extend in sealed fashion.

34. The method of one of claims 31-33, characterized in that the first forming part (32), on its side remote from the winding head (1a, 1b) forms a first seat (17), and/or that the second forming part (33), on its side remote from the winding head (1a, 1b) forms a second seat (18), and/or that the third forming part (34), on its side remote from the winding head (1a, 1b) forms a third seat (20), and/or that the fourth forming part (35), on its side remote from the winding head (1a, 1b) forms a fourth seat (21).

35. The method of one of claims 17-34, characterized in that the opening (23) is embodied as an essentially cylindrical extension (23).

36. The method of claim 35, characterized in that the cylindrical extension (23) forms at least one further seat.

37. The method of one of claims 17-36, characterized in that it further includes the provision of sealing means (9, 10, 22) on the first seat (17) and/or the second seat (18) and/or the third seat (20) and/or the fourth seat (21) and/or in the region of the further seat.

38. An apparatus for performing the method of one of the claims 17-37.
